(19) United States
(12) Patent Application Publication
(10) Pub. No.: US 2019/0217740 A1
(43) Pub. Date: Jul. 18, 2019

(54) Arrangement of Slab Assemblies and a Method of Building Such an Arrangement

(71) Applicant: Bombardier Primove GmbH, Berlin (DE)

(72) Inventors: Sergio Alejandro Perez Romero, Alsbach-Haehnlein (DE); Éanna Curran, Darmstadt (DE)

(21) Appl. No.: 16/307,262

(22) PCT Filed: Jul. 13, 2017
(86) PCT No.: PCT/EP2017/067701

§ 371 Date: Dec. 5, 2018

(30) Foreign Application Priority Data
Jul. 13, 2016 (GB) 1612158.4

(51) Int. Cl. B60M 7/00

(52) U.S. Cl. CPC B60M 7/00; B60L 9/00

(57) ABSTRACT

The invention relates to an arrangement (1) of a first slab assembly (2, 2a) and at least one further slab assembly (2, 2b, 2c), wherein each slab assembly (2, 2a, 2b, 2c) comprises a cable bearing element (20) and a section of at least one electric line (3a, 3b, 3c), wherein the at least one electric line (3a, 3b, 3c) extends from the first to the further slab assembly (2, 2a, 2b, 2c), wherein a length of the section of the at least one electric line (3a, 3b, 3c) between the first and the further slab assembly (2, 2a, 2b, 2c) is larger than zero, wherein the first and the further slab assembly (2, 2a, 2b, 2c) are foldably connected by the at least one electric line (3a, 3b, 3c).

The invention relates to an arrangement of a first slab assembly and at least one further slab assembly and a method of manufacturing such an arrangement.

WO 2014/037324 A2 discloses a pavement slab assembly for a route for vehicles driving or standing on a surface of the route, wherein the pavement slab assembly consists at least partially of pavement material and comprises a cable bearing element and one or more electric line(s). Further, the cable bearing element is embedded in the pavement material.

The described pavement slab assembly can be prefabricated and then be transported to an installation site. Such a pavement slab assembly can provide an inductive charging section, wherein inductive power transfer to a vehicle can be performed if the vehicle is arranged above the charging section. An inductive charging section requires continuous cabling of the electric line(s) along its total length. If a large length of the route-sided inductive charging section is required, a single prefabricated pavement slab assembly might be too long or too heavy to be transported and installed easily.

Thus, the production of such long prefabricated slabs to be installed in the pavement for inductive energy transfer to electric vehicles is limited by the difficulty in lifting and transporting the manufactured pavement slab assembly as it might be too long or too heavy.

There is the technical problem of providing an arrangement of pavement slab assemblies and a method of manufacturing such assemblies which allow providing a route-sided inductive charging section of a desired length, wherein the installation, in particular the transportation, of the pavement slab assemblies is facilitated.

The solution to said technical problem is provided by the subject-matter of claims 1 and 7. Further embodiments of the invention are provided by the subject-matter of the sub claims.

An arrangement of a first slab assembly and at least one further slab assembly is proposed.

A slab assembly can be a pavement slab assembly, in particular a floor slab assembly. In particular, each of the slab assemblies can be provided according to one of the embodiments described in WO 2014/037324 A2, in particular described by the claims or within the description of said publication. In other words, each of the slab assemblies can have or provide one or multiple feature(s) of the embodiments described in WO 2014/037324 A2. Thus, the disclosure of WO 2014/037324 A2, in particular the disclosure of features and aspects related to the slab assembly, are fully incorporated by reference into this disclosure.

In particular, such slab assemblies are assemblies for a route for vehicles for driving or standing on a surface of the route, in particular a route for road automobiles.

It is, however, possible that a slab assembly is a wall slab assembly. In this case, such slab assemblies can provide at least a portion of a wall, e.g. wall of a parking garage or a car park. If the slab assembly is a wall slab assembly, the slab assembly can also be referred to as panel assembly or wall panel assembly.

A floor slab assembly advantageously allows inductively transferring power to the vehicle from below. A wall slab assembly advantageously allows inductively transferring power to the vehicle from behind, from the front or from the side.

The present invention can be applied to a route for any land vehicle (including but not preferably, any vehicle which is only temporarily on land), in particular track-bound vehicles such as rail vehicles (e.g. trams), but also to road automobiles such as individual private passenger cars, trucks or public transport vehicles (e.g. busses including trolley busses which are also track-bound vehicles).

Each of the slab assembly consists at least partially of slab material. The slab material can be chosen according to the usage of the slab assembly, in particular according to an usage as a pavement slab or a wall slab. In case a of pavement slab assembly, the slab material can e.g. be concrete. In case of a wall slab assembly, the slab material can e.g. be plastic. It is, of course, possible that other materials are chosen.

In the following, the slab material will also be referred to as pavement material. It is, however, clear to the skilled person that other materials can be used as slab material.

Further, each slab assembly comprises a section of at least one electric line, preferably sections of multiple, e.g. three electric lines. In particular, the first slab assembly can comprise a first section of an electric line, wherein the further slab assembly comprises a further section of said electric line. In other words, the different slab assemblies comprise different sections of at least one common electric line, preferably different sections of multiple common electric lines.

An electric line can be provided as a cable. An electric line can provide a phase line, wherein the phase line is adapted to carry a phase current of one phase of a power supply to a primary winding structure. In particular, the electric line(s) can provide the primary winding structure of the system for inductive power transfer. If the slab assemblies comprise three electric lines, each electric line can be a phase line of a three-phase system.

The electric line(s) can have a desired geometric shape and/or arrangement in order to provide a desired primary winding structure. In other words, if the electric line(s) is/are arranged in the desired geometry and/or arrangement, a desired layout of the primary winding structure is provided. In this layout, an electromagnetic field with desired characteristics can be generated by the provided primary winding structure if supplied with an alternating current.

Further, the at least one electric line extends from the first to the further slab assembly, wherein a length of the section of the at least one electric line between the first and the further slab assembly is larger than zero. The section of the at least one electric line between the first and the further slab assembly and thus outside the first and the further slab assembly can also be referred to as intermediate section of the electric line. In particular, the at least one electric line can extend from the first to the further slab assembly without an interruption of the electric line, e.g. by an electric connector.

Each slab assembly can have or provide at least one connecting inlet/outlet for the at least one electric line, in particular at least one connecting inlet/outlet per electric line. The electric line can extend through said connecting inlet/outlet from the environment into the slab or from the slab into the environment. The inlet/outlet can be sealed.

Preferably, but not mandatorily, the at least one electric line extends through a front surface and/or a rear surface of a slab assembly. In this case, the connecting inlet/outlet is arranged at the front or rear surface of the pavement slab assembly.

The slab assembly can comprise two slabs. In this case, the first and the second slab can provide terminal slabs of the slab assembly. The slab assembly can also comprise three or more slabs. In this case, the slab assembly also comprises two terminal slabs, in particular the first and the last slab in the series connection of slabs. Further, the slab assembly comprises intermediate slabs, in particular the slabs in between the terminal slabs.

The terminal slabs can each comprise only one connecting inlet/outlet or only one connecting inlet/outlet per electric line. The intermediate slabs can each comprise two connecting inlet/outlet, in particular two connecting inlets/outlets per electric line. The two connecting inlets/outlets per electric line can be arranged at opposite surfaces of the slab, in particular at the front surface and the rear surface.

If the slab assembly comprises more than one electric line, in particular three electric lines, one of the terminal slabs can comprise a star point connection of these multiple electric lines. Moreover, the remaining terminal slab can comprise the connecting means for connecting the electric line(s) to an external power supply.

In other words, only one of the slabs of a slab assembly can comprise a star point connection of multiple electric lines, wherein the remaining slab(s) do not comprise a star point connection. Further, only one of the slabs of a slab assembly can comprise connecting means for connecting the electric line(s) to an external power supply, wherein the remaining slab(s) do not comprise such a connecting means.

If an upper or lower surface of each of the slab assemblies is arranged in a common plane, a maximal distance between the two slab assemblies can be equal to the length of the intermediate section. Of course, the distance between the two slab assemblies, in particular the distance along the longitudinal axis of the arrangement, can be chosen larger than zero but smaller than the length of the intermediate section. In other words, the slab assemblies can be arranged such that front and rear sections of different slab assemblies do not abut.

Further, the first and the further slab assembly are foldably connected by the at least one electric line. This means that the slab assemblies between which the at least one electric line extends can be moved into a folded and into an unfolded state without being disconnected.

In other words, the electric line connection allows moving the slab assemblies into a folded and into an unfolded configuration. In particular, the intermediate section of the at least one electric line can be flexible.

The arrangement can have an unfolded configuration, wherein the upper or bottom surface of each slab assembly is arranged in a common plane. Further, longitudinal axis of the slab assemblies can be parallel, in particular concentric. In the unfolded configuration, a gap can be provided in between the first and the further slab assembly, wherein the at least one electric line extends through the gap.

As mentioned before, a maximum size or length of the gap can be equal to the length of the intermediate section or can be smaller than said length. A minimum length of the gap, however, is larger than zero.

Further, the electric line can be arranged such that the intermediate section of the electric line has a desired course and/or geometry and/or arrangement. In particular, the course, geometry and arrangement can be chosen such that the course or geometry provided in the first slab assembly is continued. For instance, the electric line within the intermediate section can have a meandering course.

Further, the arrangement can have a folded configuration. In the folded configuration, upper or bottom surfaces of each slab assembly are not arranged within a common plane. In the folded configuration, corresponding surfaces, e.g. upper or bottom surfaces, of consecutive slab assemblies of the arrangement can be arranged on one another or can face each other.

For example, a bottom surface of a first slab assembly can be arranged or face a bottom surface of a further slab assembly in the folded configuration.

In particular, the slab assemblies can be stacked or piled onto each other in the folded configuration.

The length of the intermediate section of the electric line can be chosen such that the minimal bending radius in the intermediate section of the electric line is larger than a minimal admissible bending radius in the folded configuration.

In particular, the length of the section of the at least one electric line between the first and the further slab assembly can be chosen from an interval of 0.1 m to 1.0 m, preferably from 0.5 m to 0.9 m.

This advantageously allows the aforementioned handling of the slab assemblies for transport and installation while the risk of damage to the electric line is minimized. Further, the proposed arrangement of slab assemblies advantageously allows providing a primary winding structure within a route with a length larger than the length of one slab assembly. In other words, the length of charging section can be larger than the length of one slab assembly. Also, the proposed arrangement of slab assemblies advantageously allows providing a primary winding structure within a wall with a length larger than the length of one slab assembly

Further, the handling of the arrangement, in particular the transport and the installation, is facilitated. It is, for instance, possible to manufacture the arrangement at a manufacturing site in an unfolded configuration. Then, the slab assemblies can be moved to the folded configuration which can easily be transported to an installation side. At the installation side, the arrangement can be moved to the unfolded configuration before or during installation on the ground in order to provide the desired inductive charging section within the route. Alternatively, the arrangement can be moved to the unfolded configuration before or during installation on a wall in order to provide the desired inductive charging section within the wall.

According to the invention, each slab assembly comprises a cable bearing element. A cable bearing element can denote an element which is adapted to position and/or to hold a plurality of line sections of one or more electric lines.

The cable bearing element can e.g. comprise recesses forming spaces and/or projections delimiting spaces for receiving at least one of the line sections. The electric line or lines can extend through these spaces. The electric line(s) extend(s) along and/or under the surface of the route or wall, e.g. an (upper) surface of the slab assembly. In particular, the electric line(s) can extend in and/or about the travelling direction of vehicles which are driving on the surface of the slab assembly.

The cable bearing element can be formed as a shaped block which is described in GB 2485616 A. Therefore, the disclosure of GB 2485616 A is incorporated into the present description. It is possible that at least one end section of the cable bearing element can have a tapered or frustumed shape.

It may be possible to use as a pavement material the same type of material as the cable bearing element. The “same type of material” means that at least one component of the material is formed by the same chemical substance or by a similar chemical substance so that neighbouring regions of the same material have excellent surface contact or even form a common chemical compound. For example, this is the case with the material asphalt which contains bitumen (i.e. a type of hydrocarbons) as a component. Therefore, the cable bearing element and pavement material can consist of asphalt. However, the additional components of asphalt may vary, i.e. all types of asphalt contain bitumen, but may contain different additives (in particular stones). Further, the material may be an adhesive such as epoxy resins and/or hardeners in their cured stage.

Optionally, the pavement material can be different from the material of the cable bearing element. The materials, however, can be chosen such that a predetermined bonding force between the pavement material and the cable bearing element is provided. The cable bearing element can e.g. consist of a polymer. If the cable bearing elements comprises more than one subelement, each subelement can consist of a polymer. The cable bearing element can preferably be made of a high polymer. If the pavement material is concrete, the (high) polymer material advantageously provide strong bonding forces between the cable bearing element and the pavement material while a thermal expansion of the cable bearing element is small.

Further, a relative difference between the thermal expansion, e.g. the thermal expansion coefficient, of the pavement material, in particular the pavement material embedding or encasing the cable bearing element, and the thermal expansion, e.g. the thermal expansion coefficient, of the cable bearing element can be smaller than a predetermined threshold value, preferably zero or close to zero. In this case, the thermal expansion coefficients of the pavement material and the cable bearing element can be chosen accordingly. This advantageously avoids an undesired stress for and/or damages of the pavement material and the cable bearing element. In particular, a cracking of a polymer material of the cable bearing element can be avoided. This is due to the fact that both materials will deform in a similar way if a temperature change, in particular a temperature decrease, occurs.

The cable bearing element is embedded or encased in the pavement material of the slab assembly. This means that the cable bearing element is integrated into the slab assembly. Preferably, the cable bearing element is narrower (in the direction perpendicular to the travel direction) than a typical vehicle driving or standing on the route and therefore is also narrower than the slab assembly. Therefore, the vehicle shields the environment against emission from the cable bearing element.

The slab assembly can have an upper surface and a bottom surface which is located opposite to the upper surface. The upper surface of the slab can provide a surface on which vehicles can travel, i.e. a driving surface, or on which the vehicle can park, i.e. a standing surface. Optionally, an additional layer can be placed on the upper surface providing the driving or standing surface. Alternatively, the upper surface can provide a wall area.

A slab assembly can be block-shaped. In this case, the slab assembly has an upper surface, a bottom surface, and four side surfaces. Two of the side surfaces can extend in a longitudinal direction of the slab assembly. The longitudinal direction can be the direction of travel of a vehicle on the driving surface of the slab assembly. These side surfaces can be referred to as lateral surfaces, wherein the other two side surfaces face in longitudinal direction which can be referred to as front and rear surface.

The slab assembly can have a predetermined length, width, and depth. The dimensions can e.g. be chosen according to a desired usage of the slab assembly.

The width can e.g. be adapted to a desired width of a driving or standing surface, e.g. a traffic lane, or to desired dimensions of a wall panel. For example, if the slab assembly is a pavement block assembly, the slab assembly can have a length of 5 m to 10 m, a width of approximately 2 m to 4 m, and a height up to 0.25 m. It is possible that all slab assemblies of the proposed arrangement have an equal length, width and depth.

Further, the cable bearing element which is arranged within the slab assembly can be enclosed by the pavement material. The cable bearing element can, for example, be arranged within the slab assembly such that the cable bearing element is fully enclosed by the pavement material.

The term “enclosed” means that the cable bearing element or an outer surface of the cable bearing element is disposed or positioned at a first (predefined) distance from the upper surface formed by the slab assembly on the one hand and, on the other hand, disposed or positioned at a second (predefined) distance from the bottom surface formed by the slab.

In this way, the electric line(s) guided by the cable bearing element are disposed at predefined distances from the surfaces of the slab assembly.

The cable bearing element or an outer surface of the cable bearing element can also be disposed or positioned at (predefined) distances from the side surfaces, preferably the lateral surfaces, of the slab assembly. It is, however, also possible, that the cable bearing element or an outer surface of the cable bearing element can also be disposed or positioned at (predefined) distances from the front surface and rear surface.

The cable bearing element can comprise or provide at least one guiding means for the electric line(s), wherein the guiding means can be arranged and/or designed such that a desired course and/or geometry and/or arrangement of the electric line(s) is provided. Thus, if an electric line is arranged on or in the cable bearing element, the desired course or geometry and/or arrangement of the electric line(s) can be provided. Preferably, the cable bearing element comprises or provides guiding means for more than one, in particular, for three electric lines.

In particular, the electric line can have a meandering course. In this case, the cable bearing element can be designed such that the electric line is guidable with said meandering course. In other words, the electric line is guidable such that the electric line can extend along a longitudinal axis of the cable bearing element in a serpentine manner (serpentine course). This can mean that sections of the electric line which extend along the longitudinal axis are followed in each case by a section which extends transversely to the longitudinal direction which in turn are followed again by a section which extends along the longitudinal axis and so on. In case of a multiphase system, all electric lines can have a meandering course. Providing a meandering course of electric lines in the cable bearing element advantageously allows providing a primary winding structure which can generate a travelling electromagnetic field, wherein the electromagnetic field can travel along the longitudinal axis of the cable bearing element or the slab assembly. Such an embodiment is particularly useful for dynamic charging, i.e. for inductive power transfer to moving vehicles.

Alternatively, the electric line is arranged such that along the course of the electric line, at least one section of the electric line provides at least one complete loop. In this case, the guiding means for the electric lines can be designed and/or arranged such that the electric line is guidable along a course such that at least one section of the electric line provides at least one complete loop. In this case, the electric line can be guided such that at least one conductive loop with one or multiple turns is provided. Such a design advantageously allows providing a winding structure which generates the electromagnetic field with desired characteristics in a desired charging region. It is thus particularly useful for static charging, i.e. for inductive power transfer to a vehicle at a stop.

Preferably, an electric line provides at least two complete loops. Each loop can also be referred to as sub winding structure. Such a sub winding structure can provide a loop or a coil. In this case, the electric line can provide multiple sub winding structures which extend along the longitudinal axis of the cable bearing element which can be parallel to a longitudinal axis of the resulting primary winding structure. In this case, successive sub winding structures can be arranged adjacent to one another along said longitudinal axis.

Each section of the at least one electric line, in particular the sections integrated into a slab assembly can be arranged such that the desired course or geometry of the electric line is provided. The section of at least one electric line of a slab assembly can extend along and/or under the surface of said slab assembly.

It is possible that one of the slab assemblies provides at least one connecting means for connecting the electric line(s) to an external power supply. Such a connecting means can e.g. be provided by a connector or by a supply inlet/outlet. The supply inlet/outlet can be arranged at a side surface of the slab. It is further possible that one of the slab assemblies provides a star point connection of the electric lines within the slab assembly.

While or after moving the arrangement to the unfolded configuration, a desired course of the intermediate section of the electric line can be adjusted. It is, for instance possible, to provide an intermediate cable bearing element as an element separate from the arrangement before or after moving the arrangement to the unfolded state, wherein said intermediate cable bearing element can be adapted to position and/or to hold the intermediate section of the at least one electric line. Then, the intermediate section of the at least one electric line can be arranged in or on the intermediate cable bearing element.

In particular, intermediate cable bearing element can guide the electric line such that a desired course or geometry of the electric line, in particular a serpentine course, between the first and the further slab assembly is provided. The intermediate cable bearing element, however, can be designed according to one or more features of the cable bearing element of a slab assembly.

Further, the arrangement comprises the intermediate cable bearing element. In this case, the cable bearing element is part of the arrangement. This intermediate cable bearing element can also be referred to as external cable bearing element. The intermediate cable bearing element is arranged between the first and the further slab assembly, in particular in the unfolded configuration. The intermediate cable bearing element can be adapted to position and/or to hold the intermediate section of the at least one electric line. In particular, intermediate cable bearing element can guide the electric line such that a desired course or geometry of the electric line, in particular a serpentine course, between the first and the further slab assembly is provided. The intermediate cable bearing element, however, can be designed according to one or more features of the cable bearing element of a slab assembly.

In particular, the intermediate cable bearing element can be designed as a flexible cable bearing element, in particular as a bendable cable bearing element. For example, the intermediate cable bearing element can be provided by a cable chain.

Said intermediate cable bearing element advantageously allows providing a desired course or geometry of the electric line outside the slab assemblies.

In another embodiment, the length of the section of the at least one electric line between the first and the further slab assembly is larger than the sum of the heights of the first and the further slab assembly. Preferably, all slab assemblies of the arrangement have an equal height. The height can e.g. be 0.25 m. This advantageously allows stacking slab assembly onto each other while the risk of damaging the electric line is minimized.

In another embodiment, each slab assembly comprises at least one magnetic shielding element. The shielding element can be made of electrically conducting material, e.g. aluminium. The shielding element shields an electromagnetic field produced by an electric line or by electric lines so that requirements concerning electromagnetic compatibility of EMC are met. For example, other electric lines or pipings may be buried in the ground below the route or in the wall which need to be shielded against the electromagnetic field produced by the electric line(s).

Alternatively or in addition, each slab assembly comprises at least one magnetic flux guiding element. The magnetic flux guiding element can be made of magnetic core material, e.g. ferrite. Within this description, “core” does not mean that the electric lines are wound around the core, but that magnetic field lines of the electromagnetic field produced by the electric lines are bundled within the core, i.e. the magnetic flux is particularly high within the core. In particular, as mentioned above, the core space may extend in the driving direction of vehicles driving on the route and sections of the electric line(s) is/are preferably extending transversely to the extension of the core space. For example, the electric line or lines may follow a meandering path which extends in the direction of travel or along the wall. The magnetic core element may alternatively be placed at another location within the route or the wall. It is possible that the cable bearing element comprises a recess forming a core space, wherein the magnetic core element can be placed into the recess. For example, a groove may extend on the upper side of the cable bearing element in the direction of travel of vehicles or along the wall. Particularly preferred is that there is a magnetic core element and, in addition, a shielding layer.

Alternatively or in addition, the arrangement comprises an intermediate magnetic shielding element and/or at least one intermediate magnetic flux guiding element, wherein the intermediate magnetic shielding element and/or the intermediate magnetic flux guiding element is/are arranged between the first and the further slab assembly, in particular in the unfolded configuration.

In another embodiment, at least one slab assembly comprises at least one detection means for detecting a vehicle. The detection means can be designed such that a presence of a vehicle can be detected. Alternatively, the detection means can be designed such that a presence of a predetermined vehicle or class of vehicles can be detected. For example, the detection means can receive a coded signal, wherein the code contains information on which vehicle or type of vehicle has sent the signal. If a vehicle enters a detection or receiving area of the detection means, the presence of the vehicle is detected by the detection means and an output signal can be generated. The detection area is e.g. an area in which signals can be received by the detection means, e.g. an area of 10 m or 20 m around the detection means. The output signal can be used for route surveillance and/or to initiate the transfer of electric energy to consecutive sections of electric line(s) (primary windings), in particular in the direction of travel to the vehicle. This advantageously allows activating an energy transfer, e.g. supplying electric energy, to electric line(s) only if they are to be passed over or passed by the vehicle. Preferably, an inductive receiver is used for the reception of the signal sent by the vehicle which does not only receive the signal but also generates a voltage to power the detection means. For example, a RFID-device can be used. The detection means can comprise a conductor loop which is arranged in an area adjoining to the area in which the cable bearing element is located. The conductor loop can be arranged at the same height as the electric line(s) forming the primary winding with respect to a bottom surface of the slab assembly. Preferably, the conductor loop can be arranged higher as the electric line(s) forming the primary winding with respect to a bottom surface of the slab assembly, e.g. closer to the driving surface or wall surface provided by the slab assembly. It is desirable that the detection means avoids the armouring elements. Therefore, it can be arranged either above a top layer of the armouring elements or below a bottom layer of the armouring elements. The detection means can be arranged aside the cable bearing element, e.g. at a fixed distance to the cable bearing element (or an outer surface of the cable bearing element), e.g. in a direction perpendicular to the direction of travel. The detection means can be placed after the pavement material has cured, whereby slots are cut into a driving or wall surface of the slab assembly and the detection system is placed into the slot and filled with a sealant afterwards. This provides a simple method of installing induction loops in the proposed slab assembly which can be arranged e.g. at traffic lights or automatic gates in a carpark. A terminal or terminals of the detection assembly can be arranged on a side surface of the slab assembly, preferably at one of the aforementioned lateral surfaces.

In another embodiment, each slab assembly comprises at least one positioning element. The positioning element can be designed and/or arranged such that a fixed position of at least one element within the slab assembly before and during casting of pavement material can be ensured. In particular, an element of the slab assembly can be attached or fixed to the positioning element. Such an element can e.g. be the cable bearing element, a magnetic shielding element, a magnetic flux guiding element, or at least an element of the detection means. It is, of course, possible that each slab assembly comprises multiple positioning elements. A positioning element can e.g. be designed as a spacer element or a leg.

The usage of positioning elements advantageously allows retaining or fixing the cable bearing element before, during, and after the casting while electromagnetic properties of the electric line arrangement are not affected.

Alternatively or in addition, each slab assembly comprises at least one armouring element. An armouring element can denote an element which reinforces or strengthens the mechanical stability of the slab assembly. For instance, an armouring element can be designed as an armouring mesh. Further, an armouring element can be designed as an armour rod. The armouring element additionally reinforces the slab assembly. Also, the armouring element provides reinforcement to the slab assembly for lifting and transportation of the slab assembly.

Preferably, at least one positioning element can provide at least one armouring element.

Further, the at least one positioning element or the at least one armouring element is made of a non-metallic and/or non-magnetic material, in particular of plastic. The armouring element can form a reinforcing structure of high tensile strength, e.g. an armour rod. Preferably, the armouring element is made of fibre glass. The armouring element can e.g. be a fibre glass rod or an arrangement of fibre glass rods.

In another embodiment each slab assembly comprises at least one lifting element for lifting the assembly. The lifting element can be a lifting eye, a clamp, a bracket, a bolt, a U-bolt or another device which allows lifting and transporting the complete slab assembly after casting.

In a preferred embodiment, the lifting element is designed as a non-metallic carrier element which protrudes from a surface of the assembly. Preferably, the non-metallic carrier element protrudes from a side surface, for example from one or both of the aforementioned lateral surfaces, of the slab assembly. It is, however, also possible that the non-metallic carrier element protrudes from a front and/or a rear surface, especially when using precast concrete lifting devices. The non-metallic carrier element can be a non-metallic anchorage bar.

It is also possible that the lifting element, e.g. the non-metallic carrier element, is formed as a part of the aforementioned positioning element. If the positioning element is also designed as an armouring element, the lifting element, e.g. the non-metallic carrier element, is formed as a part of the aforementioned armouring element. The lifting element can e.g. be an anchorage bar which also forms a crossbar of the aforementioned reinforcement cage. In this case, one end or both ends of the crossbar can protrude from the side surfaces of the slab in order to provide the lifting elements.

This advantageously allows simple lifting and transporting from e.g. a fabrication site to a construction side.

Further, at least one of the assemblies, in particular the first slab assembly, can comprise at least one feeder line for providing electric energy to the at least one electric line. The feeder line can be at least partially shielded by a shielding conduit. The shielding conduit can be made of aluminum. The feeder line can provide an electric connection of the at least one electric line guided by the cable bearing element and an external power supply. The feeder line can e.g. be arranged such that a feeder line is let through a side surface of the slab assembly, preferably through one of the aforementioned lateral surfaces. The at least one feeder line can e.g. extend through a supply inlet/outlet as mentioned before.

Further proposed is a method of building an arrangement of a first slab assembly and at least one further slab assembly. The method advantageously allows providing an arrangement according to one of the embodiments described in this invention. Thus, the method can comprise all the steps required to provide such an arrangement. In particular, the following steps are performed. First, a first and at least one further casting mould can be provided. The first and the further casting mould can be arranged with a predetermined distance to each other. Said distance can correspond to the length of the gap of the arrangement in the unfolded configuration.

Second, a first cable bearing element can be provided and arranged in the first casting mould. Further, a further cable bearing element can be provided and arranged in the further casting mould. Further, at least one electric line, preferable multiple electric lines, can be arranged in the first and the further slab assembly such that the at least one electric line extends from the first to the further casting mould, in particular from the first to the further cable bearing element. The at least one electric line can be arranged such that a course of the electric line corresponds to a desired course. In particular, the intermediate section of the at least one electric line can be arranged such that a course of said intermediate section corresponds to a desired course, in particular a serpentine course.

Further, a length of the section of the at least one electric line between the first and the further casting mould is larger than zero. In particular, the casting moulds can be designed and/or arranged such that the slab assemblies according to one of the embodiments described in this invention can be provided if casting material is casted into the casting moulds. In particular, the casting moulds can be designed and or arranged such that said arrangement is provided in an unfolded configuration.

Further, pavement material or wall material can be casted into the gap between the at least two casting moulds. In this case, the intermediate section of the at least one electric line will be embedded into the pavement material casted into said gap.

Further, an intermediate cable bearing element is provided, wherein the intermediate cable bearing element is arranged between the first and the further casting mould. Further, at least one electric line, preferable multiple electric lines, can extend from the first to the further casting mould through the intermediate cable bearing element. After casting, the intermediate cable bearing element can be arranged between the casted first and further slab assembly.

The intermediate cable bearing element can be provided before or after casting pavement material into the casting moulds. In particular, the intermediate cable bearing element can be arranged between the first and the further slab assembly in an unfolded configuration of the arrangement. It is further possible to connect or attach the intermediate cable bearing element to the first and the further slab assembly, in particular to a front or a rear end surface of said slab assemblies.

Further, pavement material or wall material can be casted into the gap between two slab assemblies. In this case, the intermediate cable bearing element will be embedded into the pavement material casted into said gap.

The method advantageously allows fabricating arrangement off-site. Further, the method can comprise one or more of the following steps:
providing a foldable connection between the casted first and further slab assembly by the at least one electric line
providing a length of the section of the at least one electric line between the first and the further casted slab which is larger than zero, in particular larger than the sum of the heights of the first and the further slab assembly,
providing at least one magnetic shielding element for a slab assembly,
providing at least one magnetic flux guiding element for a slab assembly,
providing at least one intermediate magnetic shielding element and arranging said intermediate magnetic shielding element between the first and the further casting mould or between the first and the further casted slab assembly,
providing at least one intermediate magnetic flux guiding element and arranging said intermediate magnetic flux guiding element between the first and the further casting mould and/or between the first and the further casted slab assembly,
providing at least one detection means,
providing at least one positioning element for a slab assembly,
providing at least one armouring element for a slab assembly,
providing at least one lifting element for lifting an assembly for a slab assembly.

Further described is a route for vehicles, in particular a route for vehicles driving or standing, e.g. parking on a surface of the route. The route can comprise one or more arrangements according to one of the embodiments described in this disclosure. In particular, the arrangement can be provided in an unfolded configuration, wherein a desired driving or standing surface for vehicles is provided by the surface of the slabs of one assembly. Within the route, gaps between consecutive slab assemblies of the arrangement can be provided, wherein the electric line extends through the gap from one slab assembly to another. Such gaps can be filled by an elastically deformable material. This advantageously allows a relative movement between consecutive slab assembly of an arrangement and of the route due to movement of the underground and/or due to thermal expansion and contraction.

Further described is a method of building a route, in particular a route for vehicles driving or standing on a surface of the route, in particular for road automobiles. The method advantageously allows manufacturing a route according to one of the embodiments described in this disclosure. In particular, the following steps can be performed. First, at least one, preferable multiple, arrangements according to one of the embodiments described in this invention can be provided. Further, at least one arrangement can be installed on a prepared base or foundation such that a driving surface for vehicles which are driving on the route is provided. The arrangement can be moved to the unfolded configuration during or before installation. Further, the gap between consecutive slab assemblies can be filled, e.g. with a flexible material.

The at least one arrangement can be fabricated off site. Furthermore, the arrangement can be lifted and transported by means of lifting devices. The lifting devices can interact with lifting means of a slab assembly.

In particular, the arrangement can be fabricated in an unfolded configuration. Prior to transport, the arrangement can be moved to the folded configuration. Before or during installing the arrangement on the prepared base or foundation, the arrangement can be moved to the unfolded configuration. The base or foundation can be prepared prior to the delivery of the at least one arrangement and shall meet the pavement foundation design requirements. During building the route, the slabs of the arrangement may need to be leveled by injecting a resin or grout under the slab to provide a solid, void-free boundary under each slab and the surface of the slab which matches the design levels of the road and surrounding pavement.

The slab assembly can be installed on a base layer which may be any suitable base layer. In particular, the base layer may be made of granular material, sand cement, lean concrete or roller compacted concrete. There may be plural base layers on top of each other. However, the base layer may be an existing base layer of a route which has been used by vehicles. In this case, for example at least one layer above the base layer, or at least a part of the layer(s) above the base layer can be removed from the existing route and the slab assembly may be placed above or on the base layer. In this case, the bottom surface of the slab assembly is placed on a surface of the base layer.

It is also possible that an intermediate layer is located between the base layer and the bottom surface of the slab assembly. The intermediate layer can be used for decoupling the slab assembly and the base layer from each other, in particular for decoupling vibrations and/or relative movement due to different thermal expansion/contraction. For example, the intermediate layer may be made of asphalt or, preferably, of grouting cement.

Furthermore, the intermediate layer can enhance embedding properties for the slab assembly with respect to a surrounding. By the use of the intermediate layer, an embedding or integration of the slab assembly onto the base layer and into a pavement structure can be improved.

Furthermore, the intermediate layer can provide a flat surface for the slab assembly which provides a better support for said slab assembly. Thus, a good surface matching between the base or intermediate layer and a surface of the slab assembly is provided.

Such an intermediate layer reduces stress and, therefore, increases durability of the base layer and the slab assembly.

Further described is a wall, in particular a wall of a garage or a carpark. The wall can comprise one or more arrangements according to one of the embodiments described in this disclosure. In particular, the arrangement can be provided in an unfolded configuration, wherein a desired wall surface is provided by the surface of the slabs, i.e. panels, of one assembly. Within the wall, gaps between consecutive slab assemblies of the arrangement can be provided, wherein the electric line extends through the gap from one slab assembly to another. Such gaps can be filled by an elastically deformable material. This advantageously allows a relative movement between consecutive slab assemblies of an arrangement.

Further described is a method of building a wall, in particular a wall of a garage or a carpark, in particular for road automobiles. The method advantageously allows manufacturing a wall according to one of the embodiments described in this disclosure. In particular, the following steps can be performed. First, at least one, preferable multiple, arrangements according to one of the embodiments described in this invention can be provided. Further, at least one arrangement can be installed on a prepared wall support such that a wall surface is provided. The arrangement can be moved to the unfolded configuration during or before installation. Further, the gap between consecutive slab assemblies can be filled, e.g. with a flexible material.

Examples and preferred embodiments of the invention will be described with reference to the attached figures. The figures show:

FIG. 1 a perspective view of an arrangement in an unfolded state according to the invention,

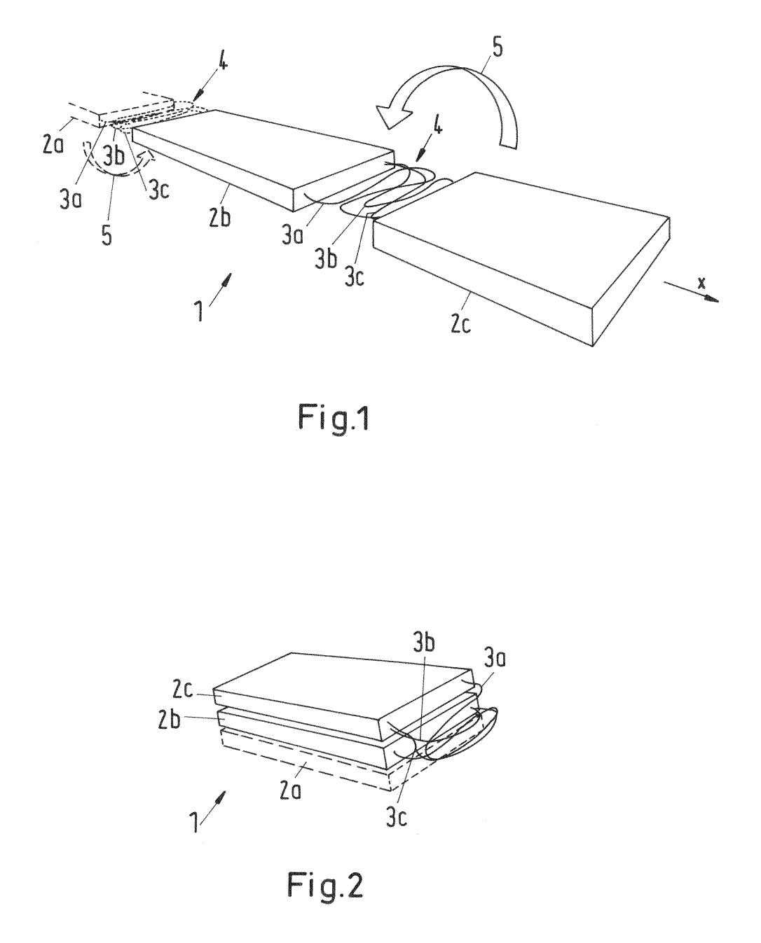

FIG. 2 a perspective view of the arrangement in a folded state,

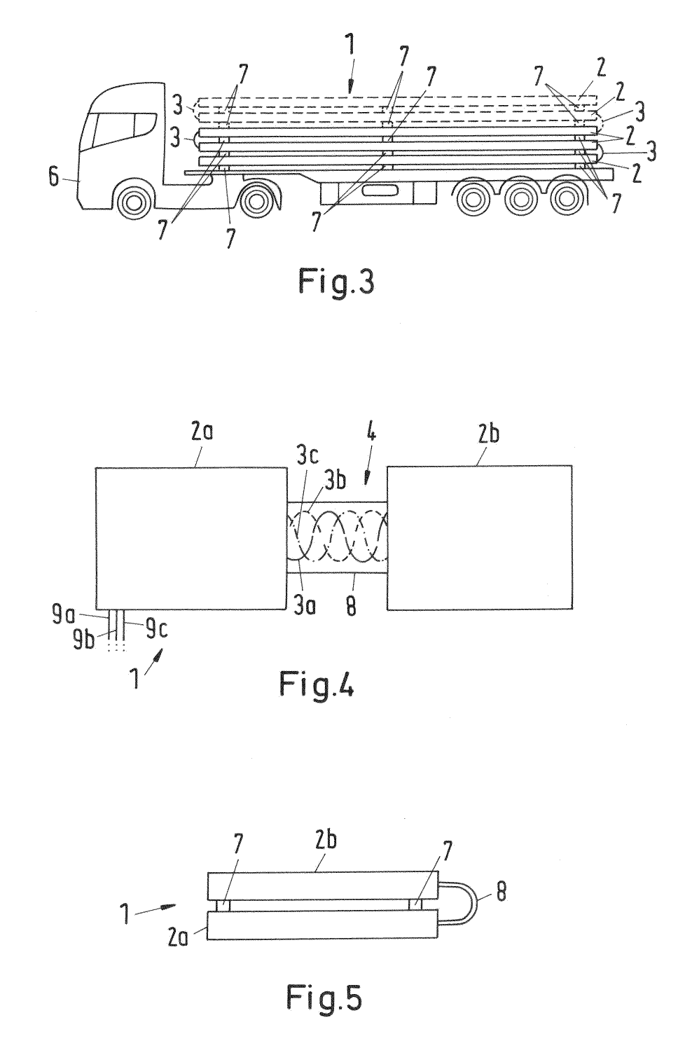

FIG. 3 a schematic side view of an arrangement on a truck,

FIG. 4 a schematic top view of an arrangement in an unfolded state according to another embodiment,

FIG. 5 a schematic side view of the arrangement shown in FIG. 4 in the folded state and

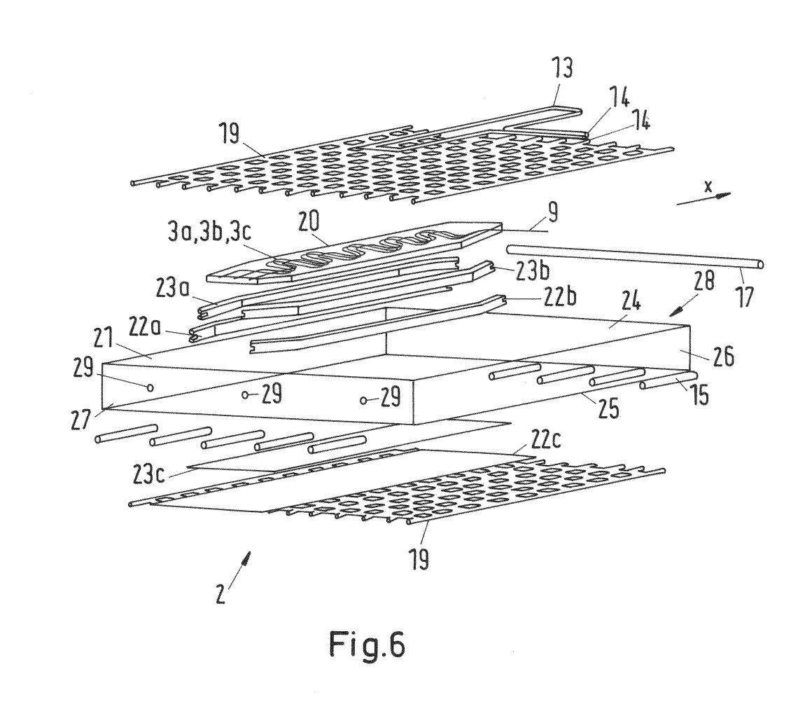

FIG. 6 an exploded view of a slab assembly

FIG. 1 shows a perspective view of an arrangement 1 of a first slab assembly 2a, a second slab assembly 2b and a third slab assembly 2c. These slab assemblies 2a, 2b, 2c can be principally designed as shown in FIG. 6. Thus, each slab assembly 2a, 2b, 2c can comprise a cable bearing element 20 and at least one electric line 3a, 3b, 3c. In the embodiment shown in FIG. 1, each slab assembly 2a, 2b, 2c comprises a first electric line 3a, a second electric line 3b and a third electric line 3c.

The shown slab assemblies can be used to provide a route for vehicles or a wall, in particular a wall of a garage or a carpark.

FIG. 1 shows the slab assemblies 2a, 2b, 2c in an unfolded state, wherein a bottom side of the slab assemblies 2a, 2b, 2c are arranged in a common plane. In this case, a gap 4 is provided between two adjacent slab assemblies 2a, 2b, 2c. The slab assemblies 2a, 2b, 2c are arranged consecutive to one another along a common longitudinal axis x of the arrangement 1, wherein the common longitudinal axis x is concentric to a longitudinal axis of each of the slab assemblies 2a, 2b, 2c. Further, the longitudinal axis x can be parallel to a direction of travel of vehicles driving on a surface of the route provided by upper surfaces of the slab assemblies 2a, 2b, 2c.

A length of the slab assemblies 2a, 2b, 2c, i.e. a dimension along the longitudinal axis x, is equal for each slab assembly 2a, 2b, 2c. Further, lengths of the gaps 4 are nonzero, in particular in a range from 0.25 m to 0.9 m.

FIG. 1 shows that the electric lines 3a, 3b, 3c extend through each of the slab assemblies 2a, 2b, 2c and through each gap 4 between the slab assemblies 2a, 2b, 2c in the unfolded state.

In FIG. 1, sections of the electric lines 3a, 3b, 3c within the slab assemblies 2a, 2b, 2c are not shown. In contrast, sections of the electric lines 3a, 3b, 3c which extend between the consecutive slab assemblies 2a, 2b, 2c are shown. These sections can be referred to as intermediate sections of the electric lines 3a, 3b, 3c. The length of said intermediate sections is larger than zero, more particular, larger than the length of the gap in the unfolded state.

It is shown that the at least one electric line 3a, 3b, 3c has a curved, in particular meandering or serpentine, course between consecutive slab assemblies 2a, 2b, 2c. The electric lines 3a, 3b, 3c provide a primary winding structure of a system for inductive power transfer. The arrangement, in particular the course, of the electric lines 3a, 3b, 3c in the gap 4 is chosen such that the electric lines 3a, 3b, 3c in the gaps 4 provide a portion of the primary winding structure. Thus, these sections also provide a portion of the electromagnetic alternating field if power is supplied to the electric lines 3a, 3b, 3c.

Further shown is that the slab assemblies 2a, 2b, 2c are foldably connected to one another. This means that the slab assemblies 2a, 2b, 2c can be moved from the unfolded state to a folded state, wherein the folded state is shown in FIG. 2. In particular, in the folded state, the slab assemblies 2a, 2b, 2c can be stapled or stacked on one another.

In the stapled configuration, an upper surface of one slab assembly 2a, 2b, 2c can face an upper surface of a consecutive slab assembly 2a, 2b, 2c. Alternatively, a bottom surface of a slab assembly 2a, 2b, 2c can face a bottom surface of a consecutive slab assembly. The electric lines 3a, 3b, 3c, in particular the intermediate sections of the electric lines 3a, 3b, 3c in the gap 4 are flexible, in particular bendable.

The movement of a slab assembly 2a, 2b, 2c into the folded state is indicated by arrows 5.

FIG. 2 shows an arrangement 1 of slab assembly 2a, 2b, 2c in the folded state. It can be seen that all slab assemblies 2a, 2b, 2c have equal dimensions. Further, a bottom surface of the first slab assembly 2a faces a bottom surface of a second slab assembly 2b. Further, a top surface of the second slab assembly 2b faces the top surface of a third slab assembly 2c in the folded configuration.

FIG. 3 shows a schematic side view of an arrangement 1 of multiple slab assemblies 2 of an arrangement 1 which are stacked in the folded configuration on a trailer of a truck 6. It is shown that the arrangement 1 in the folded configuration requires less space for transportation than in the unfolded configuration in which it is installed on the route. It is possible to arrange spacer elements 7 in between surfaces of the slab assemblies 2 in the folded configuration.

FIG. 4 shows a schematic top view of an arrangement 1 of a first slab assembly 2a and a second slab assembly 2b. Indicated are three electric lines 3a, 3b, 3c which extend through the slab assemblies 2a, 2b and through a gap 4 in between the slab assemblies 2a, 2b in the unfolded state in which the arrangement 1 is installed on or in the route. Further shown is an intermediate cable bearing element 8, wherein the intermediate cable bearing element 8 is arranged in the gap 4, in particular between the consecutive slab assemblies 2a, 2b in the unfolded state. The intermediate cable bearing element can be attached to at least one, preferably to both slab assemblies 2a, 2b. The intermediate cable bearing element 8 can be flexible, in particular bendable.

Further shown are sections of a feeder line 9a, 9b, 9c of each electric line 3a, 3b, 3c by which the respective electric line 3a, 3b, 3c is connected to an external power supply. At least one section of each of the feeder lines 9a, 9b, 9c extends within the first slab assembly 2a and through a lateral side wall of said slab assembly 2a.

In this case, the electric lines 3a, 3b, 3c can be connected by a star point connection within the second slab assembly 2b.

FIG. 5 shows a schematic side view on the arrangement 1 of slab assemblies 2a, 2b shown in FIG. 4. Shown are spacer elements 7 arranged between the slab assemblies 2a, 2b in the folded state, wherein the slab assemblies 2a, 2b are stapled. Further shown is the intermediate cable bearing element 8 which is in a bent state.

FIG. 6 shows an exploded view of an exemplary slab assembly 2, in particular of a first slab assembly 2a, of an arrangement 1 according to the invention. The slab assembly 2 comprises a cable bearing element 20 adapted to hold a plurality of line sections of electric lines 2 forming a primary winding of an arrangement for inductive power transfer. The cable bearing element 20 and consequently the electric line(s) 3a, 3b, 3c are embedded and arranged within pavement material 21 such that the cable bearing element 20 is enclosed by pavement material 21.

The slab assembly 2 further comprises a first C-shaped shielding element 22a, a second C-shaped shielding element 4b, and a third shielding element 22c which is designed as a shielding plate. Also, the slab assembly 2 comprises a first C-shaped magnetic core element 23a, a second C-shaped magnetic core element 5b, and a third magnetic core element 5c which is designed as a plate.

The first C-shaped shielding element 4a and the first magnetic core element 5a form a first one-piece magnetic shielding element. Also, the second C-shaped shielding element 4b and the second magnetic core element 23b form a second one-piece magnetic shielding element.

The first and the second magnetic shielding element are positioned aside the cable bearing element 20 such that the electric lines 3a, 3b, 3c are located in a volume located between the first and the second magnetic shielding element. The first and the second magnetic shielding element are facing each other, wherein facing each other means that the recesses formed by the C-shaped first and second magnetic shielding element are orientated against each other.

The magnetic core elements 23a, 23b form inner parts of the magnetic shielding elements while the shielding elements 22a, 22b form outer parts of the magnetic shielding elements.

The magnetic shielding element consisting of the magnetic core element 23c and the shielding element 4c is placed below the cable bearing element 20. The magnetic core element 23c forms an upper layer of magnetic shielding element while the shielding element 22c forms a bottom layer of the magnetic shielding element.

In FIG. 6 is shown that the slab assembly 2 is block-shaped. The slab 2 has an upper surface 24, a bottom surface 25, and four side surfaces. Two of the side surfaces extend along a longitudinal axis x of the slab assembly 2, e.g. in the direction of travel of a vehicle on a driving surface of the slab assembly 2 or in the direction along the wall, and are referred to as lateral surfaces 26. The other two side surfaces face in the direction of travel and are referred to as front surface 27 and rear surface 28 (see e.g. FIG. 3). The upper surface 8 forms the driving surface of a route comprising the slab assembly 2.

Further shown are outlets 29 in the front surface 27 for the electric lines 3a, 3b, 3c.

Furthermore, the pavement assembly 2 comprises a detection loop 13 which is part of a detection means. The detection loop 13 is arranged in an area adjoining to the area in which the cable bearing element 20 is located. The detection loop 13 is arranged at a higher level than the electric lines 3a, 3b, 3c with respect to the bottom surface 9 of the slab assembly 2. Terminals 14 of the detection loop 13 are arranged on a lateral surface 10 of the slab assembly 2.

The slab assembly 2 also comprises non-metallic dowel bars 15. To simplify matters, only one dowel bar 15 is denoted by a reference numeral. The dowel bars 15 can allow lifting and transporting the complete slab assembly 2 after casting. It is also possible to integrate lifting means such as a lifting eye, a clamp, a bracket, a bolt, and/or a U-bolt. These lifting means can be connected to reinforcement elements 19 of the slab assembly. It is also possible to connect a metal rope to the reinforcement elements 19 to lift the slab assembly 2. In this case, a tube, e.g. a plastic tube, can be integrated in the slab assembly 2 before casting such that the metal rope can be inserted into the tube after the pavement material has cured in order to be connected to the reinforcement elements 19. The dowel bars 15 protrude from the front surface 27 and the rear surface 28 of the slab assembly 1. The dowel bars 15 on the front and rear surface 27, 28 are specially designed for load transfer when a vehicle passes from one slab assembly 2 to the next in the direction of travel of the vehicle. Dowel bars 15 are therefore used to connect consecutive different slab assemblies which are adjacent in the direction of travel.

It is also possible that anchorage bars protrude from the lateral surfaces 10. The anchorage bars can be used to connect different slab assemblies 2 which provide adjacent traffic lanes of a route. When two adjoining lanes are built with separate slab assemblies 2, the joint between the two slab assemblies 2 is called a longitudinal construction joint. With reference to FIG. 1, the longitudinal construction point is built by a lateral surface 10 of a first slab assembly 2 and a lateral surface of a neighboring or adjacent slab assembly (not shown). An anchorage bar, for example a short piece of non-metallic material, can extend across such a longitudinal construction joint. Such anchorage bars keep the two adjoining slab assemblies from pulling away from each other, hold the facing lateral surfaces of two slab assemblies in contact and keep the surface across the construction joint flat. Hence, its function is different from the function of the dowel bars 15. An anchorage bar can be a deformed, preferably non-metallic, reinforcing element or a connector and should be designed and/or arranged such that respective construction joint does not open. Anchorage bars can be used to separate lanes for heavy traffic ways pavements. Also, anchorage bars can be designed in order to provide a load transfer element. Anchorage bars are typically used at longitudinal joints or between an edge joint and a curb or shoulder. Anchorage bars are therefore used to connect consecutive different slab assemblies 2 which are adjacent in a direction perpendicular to the direction of travel.

The dowel bars 15 and/or the anchorage bars can be part of reinforcement elements 19 of the slab assembly 1.

FIG. 1 shows that the slab assembly 2 comprises feeder lines 9 for providing electric energy to the electric lines 3a, 3b, 3c. In one embodiment, one feeder line 9a, 9b, 9c per electric line 3a, 3b, 3c can be provided. The feeder lines 9 are shielded by a shielding conduit 17. The feeder lines 9 provide an electric connection of the electric lines 3a, 3b, 3c to an external power supply (not shown). The feeder lines 9 and the shielding conduit 17 are arranged such that the feeder lines 9 are led through a lateral surface 10 of the slab assembly 2. It is, however, also possible that the feeder lines 9 exit the slab assembly 2 at the front or rear surface 27, 28 or at the upper or bottom surface 8, 9.

Further, the slab assembly 2 comprises non-metallic reinforcement elements 19 which are designed as an armouring mesh and also for lifting the slab for transport and installation. The non-metallic reinforcement elements 19, in particular the non-metallic reinforcement element 19 which is arranged below the cable bearing element 20, can provide (a) non-metallic positioning element(s), wherein the cable bearing element 20 and the positioning element(s) are arranged such that the cable bearing element 20 is positioned at a predetermined position within the slab assembly 1. The non-metallic reinforcement elements 19 and the cable bearing element 20 can be mechanically connected. Thus, the non-metallic reinforcement elements 19 can fix or retain the cable bearing element 20 in the predetermined position with regard to e.g. a casting mould during the casting process.

1. An arrangement of a first slab assembly and at least one further slab assembly, wherein each slab assembly comprises a section of at least one electric line, wherein the at least one electric line extends from the first to the further slab assembly, wherein a length of the section of the at least one electric line between the first and the further slab assembly is larger than zero, wherein the first and the further slab assembly are foldably connected by the at least one electric line,
wherein each slab assembly comprises a cable bearing element, wherein the arrangement comprises an intermediate cable bearing element, wherein the intermediate cable bearing element arranged between the first and the further slab assembly.

2. The arrangement according to claim 1, wherein the length of the section of the at least one electric line is larger than the sum of the heights of the first and the further slab assembly.

3. The arrangement according to claim 1, wherein each slab assembly comprises at least one magnetic shielding element and/or at least one magnetic flux guiding element and/or that the arrangement comprises at least one intermediate magnetic shielding element and/or at least one intermediate magnetic flux guiding element, wherein the intermediate magnetic shielding element and/or the intermediate magnetic flux guiding element is/are arranged between the first and the further slab assembly.

4. The arrangement according to claim 1, wherein at least one slab assembly comprises at least one detection means for detecting a vehicle.

5. The arrangement according to claim 1, wherein each slab assembly comprises at least one positioning element and/or at least one armouring element.

6. The arrangement according to claim 1, wherein each slab assembly comprises at least one lifting element for lifting the assembly.

7. A method of building an arrangement of a first slab assembly and at least one further slab assembly, wherein the following steps are performed:
providing a first and at least one further casting mould,
providing a first cable bearing element and arranging the first cable bearing element in the first casting mould,
providing a further cable bearing element and arranging the further cable bearing element in the further casting mould,
arranging at least one electric line in the first and the further cable bearing element such that the at least one electric line extends from the first to the further casting mould, wherein a length of the section of the at least one electric line between the first and the second casting mould is larger than zero,
casting pavement material into the casting moulds, wherein the casted first and
further slab assembly are foldably connected by the at least one electric line, wherein an intermediate cable bearing element is provided, wherein the intermediate cable bearing element is arranged between the first and the further casting mould and/or between the casted first and further slab assembly.
